(19) United States
(12) Patent Application Publication
(10) Pub. No.: US 2026/0239347 A1
(43) Pub. Date: Aug. 13, 2026

(54) NETWORK-CONTROLLED DYNAMIC SWITCHING OF UPLINK TRANSMISSION MODES

(71) Applicant: T-MOBILE INNOVATIONS LLC, Overland Park, KS (US)

(72) Inventor: Christopher Bailey, Overland Park, KS (US)

(21) Appl. No.: 19/052,037

(22) Filed: Feb. 12, 2025

(51) Int. Cl. H04W 72/21; H04B 7/0413; H04W 36/00

(52) U.S. Cl. CPC H04W 72/21; H04B 7/0413; H04W 36/00692

(57) ABSTRACT

Systems and methods are disclosed for dynamically managing uplink transmission configurations in wireless communication networks to optimize spectral efficiency and network performance. In accordance with some embodiments, a method includes receiving, via a wireless communication network, at least one uplink transmission metric from a user device. The at least one uplink transmission metric indicates uplink channel conditions. The method further includes determining, based on the at least one uplink transmission metric, that the at least one uplink transmission metric satisfies one or more predefined criteria corresponding to a first uplink transmission mode and sending, via the wireless communication network, a configuration message to the user device instructing the user device to operate in the first uplink transmission mode. The method further includes receiving, via the wireless communication network, at least one uplink transmission from the user device while the user device is operating in the first uplink transmission mode.

### TECHNICAL FIELD

Various embodiments of the present technology relate to wireless communication networks and, more particularly, systems and methods for dynamically managing uplink transmission configurations to optimize performance and spectral efficiency.

### BACKGROUND

Wireless communication networks facilitate data exchange between user equipment (UE) and base stations through uplink (UL) and downlink (DL) transmissions. Uplink transmission, where data is sent from the device to the network, is critical for applications like video calls, cloud storage, and real-time gaming. To improve UL performance, networks employ various techniques that enhance data rates, spectral efficiency, and coverage.

Two common techniques for uplink enhancement are multiple-input multiple-output (MIMO) and carrier aggregation (CA). MIMO uses multiple antennas to transmit data simultaneously, improving spectral efficiency when signal conditions allow. Carrier aggregation enables a device to transmit over multiple frequency bands, increasing data capacity and extending coverage. While both techniques are beneficial, they are typically used under different conditions, making it challenging to apply them optimally across varying network environments.

Uplink MIMO is most effective near a base station, where signal strength supports multiple transmission layers, while UL carrier aggregation is better suited for longer distances. Some networks implement uplink transmit (TX) switching, allowing a device to alternate between these techniques based on network scheduling. However, TX switching requires device-side support, and many devices lack this capability. As a result, networks often configure devices to favor one method over the other, leading to inefficient spectrum use and suboptimal uplink performance.

It is with respect to this general technical environment that aspects of the present technology disclosed herein have been contemplated. Furthermore, although a general environment has been discussed, it should be understood that the examples described herein should not be limited to the general environment identified in the background.

### BRIEF SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Various embodiments of the present technology generally relate to wireless communication networks and the management of uplink transmission configurations. More specifically, the technology disclosed herein includes systems and methods for network-controlled switching between uplink multiple-input multiple-output (MIMO) and uplink carrier aggregation (ULCA) based on real-time network conditions, without requiring uplink transmit (TX) switching support on user equipment. In a first embodiment, a method includes receiving, via a wireless communication network, at least one uplink transmission metric from a user device. The at least one uplink transmission metric indicates uplink channel conditions. The method further includes determining, based on the at least one uplink transmission metric, that the at least one uplink transmission metric satisfies one or more predefined criteria corresponding to a first uplink transmission mode. The method further includes sending, via the wireless communication network, a configuration message to the user device instructing the user device to operate in the first uplink transmission mode. The method further includes receiving, via the wireless communication network, at least one uplink transmission from the user device while the user device is operating in the first uplink transmission mode.

In some embodiments, the method further includes determining that the at least one uplink transmission metric satisfies one or more predefined second criteria corresponding to a second uplink transmission mode and sending, via the wireless communication network, a second configuration message to the user device instructing the user device to switch to the second uplink transmission mode. In some embodiments, the first uplink transmission mode is an uplink multiple-input multiple-output (UL MIMO) mode and the second uplink transmission mode comprises an uplink carrier aggregation (ULCA) mode. The second configuration message may further instruct the device to release one or more UL MIMO resources before switching to the second uplink transmission mode, in some examples. The one or more predefined second criteria corresponding to the second uplink transmission mode are satisfied when the one or more predefined criteria are not satisfied, in some implementations. In some embodiments, the at least one uplink transmission metric includes at least one of a sounding reference signal, a demodulation reference signal, a transmit precoding matric indicator, and hybrid automatic repeat request feedback. The configuration message may include a radio resource control message. The predefined criteria corresponding to the first uplink transmission mode includes a threshold for one or more of signal quality, signal strength, and transmission reliability, in some examples.

In an alternative embodiment, a system includes one or more computer-readable storage media, a processing system operatively coupled with the one or more computer-readable storage media, and program instructions stored on the one or more computer-readable storage media. The program instructions, when read and executed by the processing system, direct the processing system to at least receive, via a wireless communication network, at least one uplink transmission metric from a user device. The at least one uplink transmission metric indicates uplink channel conditions. The program instructions further direct the processing system to determine, based on the at least one uplink transmission metric, that the at least one uplink transmission metric satisfies one or more predefined criteria corresponding to a first uplink transmission mode. The program instructions further direct the processing system to send, via the wireless communication network, a configuration message to the user device instructing the user device to operate in the first uplink transmission mode and receive, via the wireless communication network, at least one uplink transmission from the user device while the user device is operating in the first uplink transmission mode.

In yet another embodiment, one or more non-transitory computer-readable storage media have program instructions stored thereon that, when executed by a computing system, direct the computing system to perform certain operations. The operations include receiving, via a wireless communication network, at least one uplink transmission metric from a user device. The at least one uplink transmission metric indicates uplink channel conditions. The operations further include determining, based on the at least one uplink transmission metric, that the at least one uplink transmission metric satisfies one or more predefined criteria corresponding to a first uplink transmission mode. The operations further include sending, via the wireless communication network, a configuration message to the user device instructing the user device to operate in the first uplink transmission mode and receiving, via the wireless communication network, at least one uplink transmission from the user device while the user device is operating in the first uplink transmission mode.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an overview of a wireless communications environment in which some embodiments of the present technology may be implemented;

FIG. 2 illustrates an example of uplink transmission using carrier aggregation (CA) in accordance with some embodiments of the present technology;

FIG. 3 illustrates an example of uplink transmission using multiple-input multiple-output (MIMO) in accordance with some embodiments of the present technology;

FIG. 4 is a first flowchart illustrating a series of steps performed by an access node in accordance with some embodiments of the present technology;

FIG. 5 is a second flowchart illustrating a series of steps performed by an access node in accordance with some embodiments of the present technology;

FIG. 6 is a third flowchart illustrating a series of steps performed by an access node in accordance with some embodiments of the present technology;

FIG. 7 illustrates an example of a wireless communication network in accordance with some embodiments of the present technology;

FIG. 8 illustrates an example of user equipment in accordance with some embodiments of the present technology; and

FIG. 9 illustrates an example of an access node suitable for implementing various operational environments, architectures, processes, scenarios, and sequences discussed herein.

### DETAILED DESCRIPTION

The present technology includes systems and methods for dynamically managing uplink transmission configurations in wireless communication networks to optimize spectral efficiency and network performance. By leveraging real-time network measurements, the system enables network-controlled switching between uplink (UL) multiple-input multiple-output (MIMO) and uplink carrier aggregation (ULCA) based on signal conditions and device capabilities. This approach allows user equipment (UE) to utilize UL MIMO in favorable conditions near the cell center and transition to ULCA when MIMO performance degrades, without requiring uplink transmit (TX) switching support on the device. The technology disclosed herein improves overall network efficiency by allocating uplink transmission resources based on actual channel conditions rather than static configuration preferences.

Many modern devices support both ULCA and UL MIMO transmission. However, a significant portion of these devices lack uplink transmit (TX) switching capabilities. TX switching allows a device to dynamically alternative between UL MIMO and ULCA based on network conditions. Without TX switching functionality, user devices are stuck operating in only one mode all the time, which is usually ULCA. As a result, devices that might benefit from UL MIMO in strong signal conditions remain locked in the single transmission mode, even when the other mode would be more efficient. This limitation leads to suboptimal spectral efficiency, unnecessary performance degradation, and inefficient use of available network resources.

Thus, in accordance with the present disclosure, an access node (e.g., eNodeB, gNodeB, and the like) monitors uplink transmission metrics received from a user device to determine whether UL MIMO or ULCA should be used. These metrics may include but are not limited to sounding reference signals (SRS), demodulation reference signals (DMRS), transmit precoding matrix indicators (TPMI), and hybrid automatic repeat request (HARQ) feedback. The access node compares the received metrics to predefined criteria associated with UL MIMO capability. Examples of such criteria include but are not limited to signal strength thresholds, channel quality indicators, and/or spatial correlation between antenna elements. UL MIMO is generally most effective when the user device is near the cell center, where higher signal quality allows for reliable multi-layer transmission. If the metrics indicate that UL MIMO is supported under current conditions, the access node transmits a configuration message to the user device instructing it to switch to operating in UL MIMO mode.

If the predefined UL MIMO criteria are not met, the user device remains in its current operating mode (i.e., ULCA) and the access node continues to monitor uplink transmission metrics and assess whether conditions warrant a mode reconfiguration. When the access node determines that a transition to UL MIMO from ULCA is appropriate it transmits a reconfiguration message instructing the device to switch modes.

Once the user device has switched to UL MIMO, the access node receives uplink transmissions from the device in UL MIMO mode and continues to monitor transmission metrics. If network conditions change, such as when the user device moves closer to or farther from the cell center, the access node dynamically reevaluates the uplink metrics and determines whether the device should switch back to ULCA and sends a reconfiguration message when switching back to ULCA is appropriate.

Various technical effects may be appreciated from the implementations disclosed herein. Such technical effects include improved spectral efficiency, optimized uplink transmission resource allocation, and enhanced network adaptability to real-time conditions. By eliminating the need for TX switching support on user devices, the disclosed technology extends the benefits of dynamic uplink mode selection to a broader range of devices without requiring hardware modifications. These improvements create a more efficient and scalable wireless network that enhances the user experience through increased uplink throughput and reduced latency.

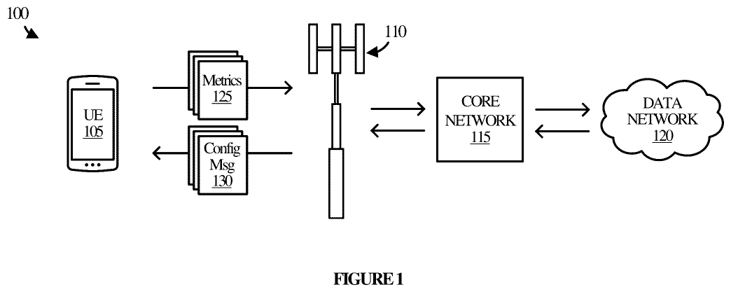

FIG. 1 illustrates wireless communications environment 100. Wireless communications environment 100 includes user equipment (UE) 105, access node 110, core network 115, data network 120, metrics 125, and configuration message 130. The components shown in FIG. 1 are merely for purposes of example, and wireless communications environment 100 may include additional, fewer, or different elements than those illustrated in the example of FIG. 1.

In accordance with the present example, UE 105 is representative of a wireless user device. Exemplary user devices include phones, smartphones, tablets, laptops, and other wireless communication devices capable of uplink transmissions in a wireless network. UE 105 may include radio transceiver circuitry (XCVR), antennas, digital signal processing (DSP) components, amplifiers, filters, memory, as well as a central processing unit (CPU) and associated user circuitry for device operation. UE 105 supports both ULCA and UL MIMO transmission modes but does not include uplink transmit switching capabilities. As a result, UE 105 is configured to operate in either UL MIMO or ULCA at a given time, with mode selection managed by an access nodes based on real-time uplink transmission metrics. UE 105 wirelessly communicates with data network 120 via access node 110 and core network 115.

Access node 110 represents a network infrastructure element that facilitates wireless communication between UE 105 and the broader network. Access node 110 may be a base station, gNodeB (gNB), eNodeB (eNB), small cell, or other radio access network (RAN) node capable of managing uplink and downlink transmission. Access node 110 may include radio transceiver circuitry, multiple antennas, a baseband processor, DSP components, memory, and one or more processors that execute network control operations. Access node 110 is configured to receive uplink transmission metrics from user devices including UE 105, compare the metrics to predefined criteria, and determine whether UE 105 should operate in UL MIMO or ULCA transmission mode. Access node 110 is further equipped with a radio resource control (RRC) module and scheduling components to transmit configuration or reconfiguration messages to user devices (e.g., UE 105), instructing them to operate in a certain uplink transmission mode. Access node 110 is also communicatively coupled to core network 115 and data network 120 to facilitate end-to-end connectivity and network resource management.

Core network 115 represents a central network infrastructure responsible for managing control signaling, mobility, authentication, and data routing between access node 110 and external networks (e.g., data network 120). Core network 115 may be representative of a third generation (3G) network, fourth generation (4G) network, fifth generation (5G) network, sixth generation (6G) network, or other wireless core network architectures. Core network 115 includes control plane functions such as mobility management, session management, authentication, and policy enforcement, as well as user plane functions for data transport and routing. Core network 115 facilitates communication between access node 110 and data network 120, ensuring that uplink and downlink transmission from UE 105 are properly routed to their destination. Access node 110 provides the wireless link between UE 105 and core network 115, while core network 115 processes and forwards user data and control messages.

Data network 120 represents an external network infrastructure that facilitates data exchange between core network 115 and various external services, applications, or computing resources. Data network 120 may include the internet, a private enterprise network, a cloud computing platform, an edge computing system, or the like. Data network 120 is responsible for receiving, processing, and delivering data packets transmitted by UE 105 via access node 110 and core network 115, as well forwarding downlink data for UE 105. Data network 120 supports various communication protocols, security mechanisms, and traffic management functions to ensure reliable and efficient data delivery.

UE 105, as shown in FIG. 1, periodically transmits metrics 125 to access node 110 to provide real-time feedback on its current uplink channel conditions. The frequency of metric transmissions may depend on network configurations and can vary based on factors such as network load, channel dynamics, and scheduling policies. For example, sounding reference signals (SRS) may be sent at predefined intervals, such as every few milliseconds, while demodulation reference signals (DMRS) and hybrid automatic repeat request (HARQ) feedback may be transmitted more frequently, synchronized with uplink data transmissions. These metrics may provide access node 110 with information on operating conditions such as signal-to-noise ratio (SNR), spatial correlation, interference levels, and available bandwidth. Based on this information, access node 110 assesses whether UL MIMO or ULCA is more suitable under current conditions.

If UE 105 is currently operating in UL MIMO, access node 110 may determine that a mode transition to ULCA is necessary if the SNR drops below a predefined threshold, spatial correlation weakens due to movement, or uplink transmission errors increase. Conversely, if UE 105 is in ULCA, access node 110 may determine that conditions now support UL MIMO if signal quality improves, multipath propagation allows for effective spatial multiplexing, or network capacity constraints make MIMO more efficient.

Upon determining that a mode transition is required, access node 110 transmits configuration message 130 to UE 105, instructing it to switch to either UL MIMO or ULCA. This message, in some examples, is a radio resource control (RRC) reconfiguration message, and may include updated parameters defining the number of transmission layers, modulation schemes, power allocation, and frequency resource assignments. Upon receiving configuration message 130, UE 105 applies the new uplink transmission mode by adjusting its radio transceiver settings and/or reconfiguring its baseband processing parameters. For instance, if switching from UL MIMO to ULCA, UE 105 may deactivate multiple uplink transmission layers and configure its transmission to utilize multiple component carriers across different frequency bands. If switching from ULCA to UL MIMO, UE 105 may modify its transmission chain to enable spatial multiplexing, thereby transmitting data streams across multiple antennas, if available. Throughout this process, uplink transmission is maintained without requiring device-side TX switching, as the mode transitions are network-controlled. Access node 110 continues to monitor uplink transmission metrics 125, ensuring that UE 105 remains in the most appropriate transmission mode based on real-time network conditions.

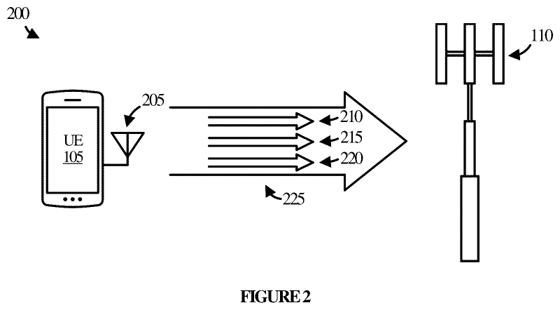

FIG. 2 illustrates ULCA environment 200. ULCA environment 200 is representative of a scenario in which a user device is using the ULCA uplink transmission mode. ULCA environment 200 includes UE 105, access node 110, component carrier (CC) 210, component carrier (CC) 215, component carrier (CC) 220, and carrier aggregation (CA) band 225. UE 105 includes antenna 205. The components shown in FIG. 2 are merely for purposes of example, and ULCA environment 200 may include additional, fewer, or different elements than those illustrated in the example of FIG. 2.

ULCA is a transmission mode that enhances data throughput by combining multiple component carriers (CCs) to increase the total available bandwidth for uplink transmissions. A primary component carrier (PCC) manages control signaling, while one or more secondary component carriers (SCCs) provide additional capacity. These carriers can be either contiguous within the same frequency band or non-contiguous across different bands, depending on network configuration and spectrum availability. A user device transmits data simultaneously over multiple CCs using separate radio frequency (RF) chains or a single RF chain with frequency division multiplexing.

Thus, as shown in FIG. 2, UE 105 transmits uplink data to access node 110 using ULCA across multiple CCs. Antenna 205 is one of multiple antennas of UE 105, which is capable of transmitting signals over multiple frequency bands. The uplink transmission is divided among multiple CCs, including a primary component carrier (CC 210) and two secondary component carriers (CC 215 and CC 220). These CCs operate on different frequency bands and are assigned by access node 110 based on network conditions and available spectrum. UE 105 modulates and encodes the data for each component carrier and transmits them in parallel through antenna 205. The signals are transmitted simultaneously over different frequency bands, effectively increasing the total available uplink bandwidth.

To aggregate the component carriers, UE 105 coordinates the simultaneous use of multiple carriers before sending them. Each carrier is transmitted separately over its assigned frequency band, but they are managed as a single uplink transmission at the Medium Access Control (MAC) layer of UE 105. The RF transceiver of UE 105 ensures that the multiple carriers are properly transmitted through the physical antenna system. Access node 110 receives these separate carriers and processes them together as a single aggregated data stream within the carrier aggregation band, CA band 225. Processing the carriers includes demodulation, decoding, and reassembly of the data packets received from each component carrier. Access node 110 schedules and manages the use of component carriers dynamically, adjusting carrier allocations based on uplink transmission metrics, network load, and spectrum availability to optimize overall uplink performance.

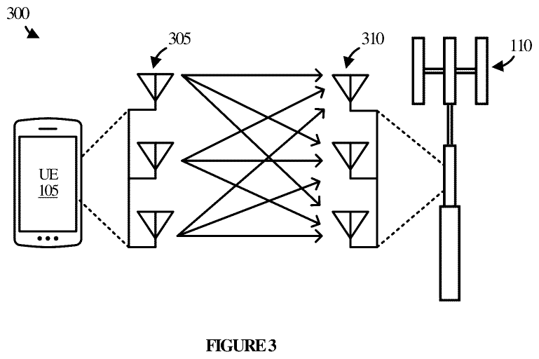

FIG. 3 illustrates UL MIMO environment 300. UL MIMO environment 300 is representative of a scenario in which a user device is operating in the UL MIMO uplink transmission mode. UL MIMO environment 300 includes UE 105 and access node 110. UE 105 includes antennas 305 and access node 110 includes antennas 310. The components shown in FIG. 3 are provided for illustrative purposes, and UL MIMO environment 300 may include additional, fewer, or different elements depending on the specific implementation.

UL MIMO is a transmission mode that increases uplink capacity and spectral efficiency by utilizing multiple antennas at both the transmitting device and the receiving access node. In this mode, a user device transmits multiple parallel data streams through multiple antennas on the device, with each stream being transmitted over the same frequency band using different spatial dimensions. The access node receives these spatially multiplexed signals via its antennas and applies MIMO detection techniques to separate and decode the individual streams. Such MIMO detection techniques may include but are not limited to linear minimum mean square error (LMMSE) estimation, successive interference cancellation (SIC), and maximum likelihood (ML) detection. Spatial multiplexing enables the user device to achieve higher data rates without requiring additional spectrum. The access node may dynamically schedule uplink MIMO transmissions based on network conditions and device capabilities.

Thus, as shown in FIG. 3, UE 105 transmits uplink data to access node 110 using UL MIMO across multiple spatial layers. The multiple transmit antennas of UE 105, antennas 305, enable UE 105 to send independent data streams simultaneously over the same frequency band via spatial multiplexing. UE 105 divides the uplink transmission into separate MIMO layers, with each layer carrying a unique data stream. UE 105 modulates and encodes the data streams independently before transmitting them via antennas 305. UE 105 transmits the signals simultaneously over the same frequency band, effectively increasing the total available uplink capacity. Access node 110, via multiple receive antennas (antennas 310), receives these spatially multiplexed data streams and applies MIMO detection techniques to separate and decode them. The number of spatial layers may be determined based on factors such as channel conditions, spatial correlation, and/or UE capability.

To reconstruct the transmitted data, access node 110 receives and processes the spatially multiplexed signals from UE 105. Access node 110 receives the streams across antennas 310 and performs channel estimation, demodulation, and MIMO decoding at the physical layer. Spatial processing techniques such as zero-forcing (ZF), minimum mean square error (MMSE), and successive interference cancellation (SIC) may be used by access node 110 to distinguish and separate the transmitted streams. A medium access control (MAC) layer of access node 110 manages scheduling and resource allocation for the UL MIMO transmission to ensure that the network efficiently utilizes available spatial layers. An RF transceiver of access node 110 processes the received signals and extracts the independent data streams using the estimated channel matrix. Access node 110 dynamically schedules and manages UL MIMO transmissions based on real-time uplink transmission metrics, spatial correlation, and network load conditions to optimize spectral efficiency and uplink performance.

The selection between the ULCA mode shown in FIG. 2 and the UL MIMO mode shown in FIG. 3 is determined by access node 110, based on real-time uplink transmission metrics received from UE 105. Access node 110 evaluates factors such as signal quality, spatial correlation, interference levels, and device capabilities to decide which mode is more suitable for a given set of network conditions. UL MIMO may be preferred when UE 105 is in a strong signal environment with sufficient spatial diversity, allowing multiple independent data streams to be transmitted efficiently. In contrast, ULCA may be used when UL MIMO conditions are not favorable, such as when spatial correlation is low, or UE 105 is farther from access node 110, making it more effective to aggregate multiple frequency carriers for increased uplink bandwidth.

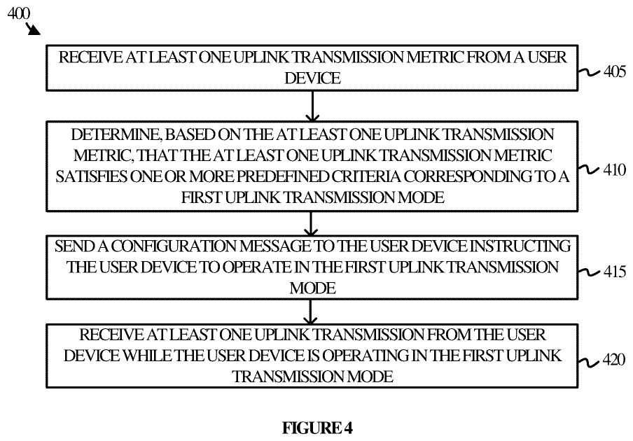

FIG. 4 illustrates process 400. Process 400 is an exemplary operation of the network-controlled selection of uplink transmission modes in wireless communications environment 100. The operations may vary in other examples. The operations of process 400 are performed by an access node, such as access node 110 in the example of FIG. 1.

The operations of process 400 include receiving at least one uplink transmission metric from a user device (step 405). In the example of FIG. 1, access node 110 receives metrics 125 sent by UE 105. UE 105 periodically transmits metrics 125 to access node 110 to provide real-time feedback on its current uplink channel conditions. The frequency of metric transmissions may depend on network configurations and can vary based on factors such as network load, channel dynamics, and scheduling policies. For example, sounding reference signals may be sent at predefined intervals (e.g., every few milliseconds), while demodulation reference signals and hybrid automatic repeat request feedback may be transmitted more or less frequently, synchronized with uplink data transmissions. These metrics provide access node 110 with information on operating conditions such as signal-to-noise ratio, spatial correlation, interference levels, available bandwidth, and the like.

The operations of process 400 further include determining, based on the at least one uplink transmission metric, that the at least one uplink transmission metric satisfies one or more predefined criteria corresponding to a first uplink transmission mode (step 410). In the example of FIG. 1, access node 110 determines, based at least in part of metrics 125, that the current operating conditions for UE 105 satisfy one or more predefined criteria corresponding to the other uplink transmission mode that UE 105 is not already operating in.

In one example, UE 105 may be operating in the ULCA uplink transmission mode. The predefined criteria for switching from ULCA to UL MIMO can relate to signal quality, spatial correlation, channel conditions, or similar metrics that indicate favorable conditions for multi-layer transmission. Access node 110 evaluates uplink transmission metrics such as sounding reference signals to assess spatial correlation, signal-to-noise ratio to determine link quality, and demodulation reference signals to estimate channel conditions. If these metrics meet or exceed a predefined threshold—such as sufficient spatial diversity between transmission paths, high SNR, and low inter-layer interference—access node 110 may determine that UL MIMO can be supported efficiently and UE 105 should therefore switch to UL MIMO.

In an alternative example, UE 105 may be operating in the UL MIMO uplink transmission mode. The predefined criteria for switching from UL MIMO to ULCA can include degraded signal quality, reduced spatial correlation, or increased inter-layer interference, which indicate that multi-layer transmission is no longer effective. Access node 110 evaluates uplink transmission metrics such as sounding reference signals to measure spatial correlation, signal-to-noise ratio to assess link quality, and hybrid automatic repeat request feedback to detect increased retransmissions or decoding errors. If these metrics fall below a predefined threshold—such as low spatial diversity, poor SNR, or high inter-stream interference—access node 110 may determine that ULCA would provide more reliable uplink performance and UE 105 should therefore switch to ULCA.

The operations of process 400 further include sending a configuration message to the user device instructing the user device to operate in the first uplink transmission mode (step 415). In the example of FIG. 1, access node 110 sends configuration message 130 to UE 105 instructing UE 105 to switch its uplink transmission mode.

Configuration message 130, in some embodiments, is a control signaling message. This message may be sent as part of the RRC signaling protocol used in LTE, 5G new radio (NR), and other wireless communication standards. In a 4G LTE network, configuration message 130 may be an RRC connection reconfiguration message delivered over the signaling radio bearer (SRB) to modify UE uplink parameters. In a 5G NR network, it may be an RRC reconfiguration message, which includes updated MAC and physical layer settings for switching between UL MIMO and ULCA. The message may also be encoded in MAC control elements (CE) for faster layer 2-based reconfiguration, or in some cases, carried within downlink control information (DCI) messages via the physical downlink control channel (PDCCH) to enable low-latency mode switching. The exact format and protocol of configuration message 130 may vary based on network deployment strategies and signaling efficiency requirements, among other factors.

In one example, UE 105 may be operating in the ULCA transmission mode. Upon determining that metrics 125 satisfy the predefined criteria for UL MIMO, access node 110 sends configuration message 130 to UE 105 instructing UE 105 to switch to the UL MIMO uplink transmission mode. In some cases, configuration message 130 may include parameters such as the number of spatial transmission layers, antenna precoding information, modulation and coding schemes (MCS), and power allocation settings for multi-layer uplink transmission. The message may also indicate the specific reference signals (e.g., SRS, DMRS) to be used for MIMO channel estimation, along with any updated scheduling grants or resource block assignments needed to support UL MIMO operation.

Upon receiving configuration message 130, UE 105 processes the message and applies the updated uplink transmission parameters. Applying the updated uplink transmission parameters may include deactivating secondary component carriers, reconfiguring the transmit chain to enable multiple spatial layers, adjusting modulation and coding schemes (MCS) to match UL MIMO transmission requirements, and the like. UE 105 may also update its antenna precoding settings, power allocation strategy, and/or transmission scheduling to align with the new MIMO configuration. Additionally, UE 105 may initiate SRS transmissions to allow access node 110 to estimate the MIMO channel and optimize spatial multiplexing.

In another example, UE 105 may be operating in the UL MIMO transmission mode. Upon determining that metrics 125 satisfy the predetermined criteria for ULCA, access node 110 send configuration message 130 to UE 105 instructing UE 105 to switch to the ULCA uplink transmission mode. In some cases, configuration message 130 may include parameters such as the deactivation of multiple spatial transmission layers, reassignment of frequency resources for component carriers, updated modulation and coding schemes (MCS), and power control adjustments for single-layer transmission. The message may also specify which primary and secondary component carriers to use, reference signals for uplink synchronization, and any changes to HARQ or scheduling grants to optimize ULCA operation.

Upon receiving configuration message 130, UE 105 processes the message and applies the updated uplink transmission parameters. Applying the updated uplink transmission parameters may include disabling multiple spatial transmission layers, reducing the number of active transmit antennas, reallocating transmission power to a single-layer uplink scheme, and the like. UE 105 may also activate secondary component carriers as assigned by access node 110, adjust its modulation and coding schemes for frequency-based carrier aggregation, and/or update its scheduling parameters to align with ULCA operation. UE 105 may additionally modify its reference signal transmissions, such as adjusting SRS usage to support frequency-domain channel estimation rather than spatial multiplexing.

Process 400 further includes receiving at least one uplink transmission from the user device while the user device is operating in the first uplink transmission mode (step 420). In the example of FIG. 1, access node 110 receives at least one uplink transmission from UE 105 while UE 105 is operating in the new transmission mode that it switched to in response to the configuration message sent in step 415.

In one example, UE 105 switched to UL MIMO in response to configuration message 130. In receiving an uplink transmission from UE 105 while it is operating in UL MIMO, access node 110 processes multiple independent data streams transmitted simultaneously over the same frequency band using spatial multiplexing. These uplink transmissions may include user data packets, control signaling, HARQ acknowledgments, reference signals such as demodulation reference signals (DMRS) for channel estimation, and/or other uplink transmissions. Since UL MIMO utilizes multiple antennas at both UE 105 and access node 110, the received signals undergo MIMO detection techniques such as ZF, MMSE, and/or SIC to separate and decode the spatially multiplexed data streams. Each receive antenna at access node 110 captures a combination of the transmitted streams, and signal processing techniques use channel state information (CSI) to reconstruct the original data streams.

In another example, UE 105 switched to ULCA in response to configuration message 130. In receiving an uplink transmission from UE 105 while it is operating in ULCA, access node 110 receives data transmitted over multiple CCs that are aggregated to increase total uplink bandwidth. These transmissions may include user data packets, control signaling, HARQ feedback, and reference signals such as DMRS for per-carrier channel estimation. Since ULCA transmits separate data streams on different frequency bands, access node 110 receives each component carrier independently using multiple RF chains. The received carriers are then processed and aggregated at the MAC layer, where access node 110 demodulates, decodes, and reassembles the data streams into a unified uplink transmission.

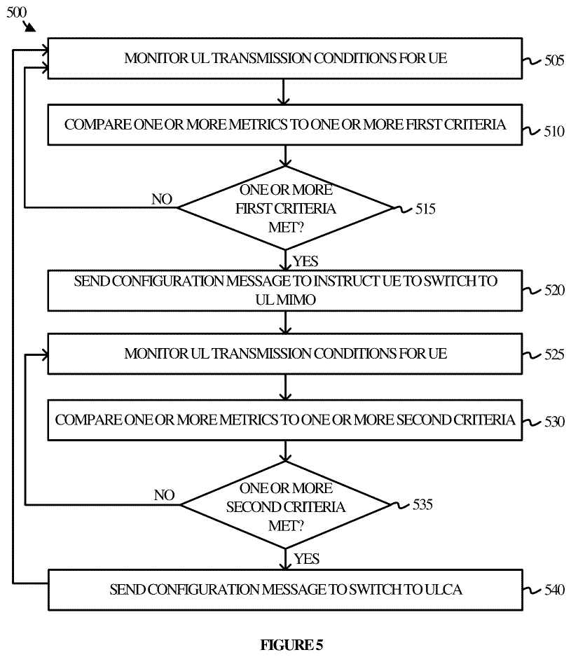

FIG. 5 illustrates process 500. Process 500 is an exemplary operation of the network-controlled switching of uplink transmission modes in wireless communications environment 100. Process 500 is an example of an embodiment in which two different criteria are used for ULCA and UL MIMO. The operations may vary in other examples. The operations of process 500 are performed by an access node, such as access node 110 in the example of FIG. 1.

The operations of process 500 include monitoring uplink transmission conditions for user equipment (step 505). In step 505, the UE is operating in the ULCA transmission mode. In the example of FIG. 1, access node 110 monitors uplink transmission conditions for UE 105 using metrics 125 while UE 105 is using ULCA. The operations of process 500 further include comparing one or more metrics associated with the UL transmission conditions to one or more first criteria (step 510). In the example of FIG. 1, access node 110 compares at least one metric of metrics 125 to predetermined criteria associated with the determination to switch from ULCA to UL MIMO. The one or more first criteria, in some examples, includes at least one threshold for signal quality, signal strength, and/or transmission reliability. The operations of process 500 further include determining whether the one or more first criteria are met (step 515). In the example of FIG. 1, access node 110 determines whether one or more metrics of metrics 125 satisfy the predetermined criteria associated with the determination to switch from ULCA to UL MIMO.

If the one or more first criteria are not met, the operations of process 500 return to step 505, monitoring uplink transmission conditions for the UE. If the one or more first criteria are met, the operations of process 500 proceed to step 520, sending a configuration message to instruct the UE to switch to UL MIMO. In the example of FIG. 1, access node 110 sends configuration message 130 to UE 105 to instruct UE 105 to switch to the UL MIMO uplink transmission mode. In some examples, the configuration message also instructs UE 105 to release one or more ULCA resources before switching to UL MIMO. The operations of process 500 further include monitoring the uplink transmission conditions for the UE (step 525). In the example of FIG. 1, UE 105 switches to UL MIMO from ULCA in response to the configuration message sent in step 520. Once UE 105 has switched, access node 110 monitors the uplink transmission conditions for UE 105 via one or more metrics of metrics 125.

The operations of process 500 further include comparing the one or more metrics to one or more second criteria (step 530). In the example of FIG. 1, access node 110 compares at least one metric of metrics 125 sent by UE 105 to predetermined criteria associated with the determination to switch to ULCA from UL MIMO. The one or more second criteria, in some examples, includes at least one threshold for signal quality, signal strength, and/or transmission reliability. The operations of process 500 further include determining whether the one or more second criteria are met (step 535). In the example of FIG. 1, access node 110 determines whether one or more metrics of metrics 125 satisfy the predetermined criteria associated with the determination to switch from UL MIMO to ULCA.

If the one or more second criteria are not met, the operations of process 500 return to step 525, monitoring uplink transmission conditions for the UE while the UE is operating in UL MIMO. If the one or more second criteria are met, the operations of process 500 proceed to step 540, sending a configuration message to instruct the UE to switch to ULCA. In the example of FIG. 1, access node 110 sends configuration message 130 to UE 105 to instruct UE 105 to switch to the ULCA uplink transmission mode. In some examples, the configuration message also instructs UE 105 to release one or more UL MIMO resources before switching to ULCA. The operations of process 500 return to monitoring the uplink transmission conditions for the UE (step 505). In the example of FIG. 1, UE 105 switches to ULCA from UL MIMO in response to configuration message 130 and access node 110 monitors one or more metrics of metrics 125 while UE 105 operates in ULCA.

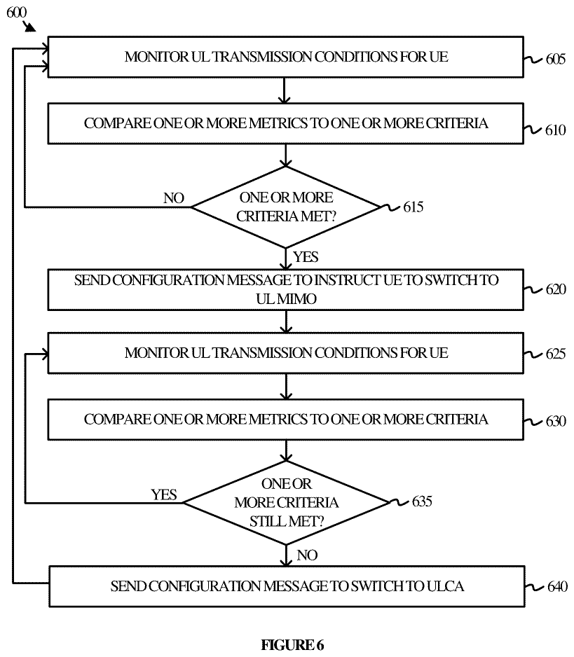

FIG. 6 illustrates process 600. Process 600 is an exemplary operation of the network-controlled switching of uplink transmission modes in wireless communications environment 100. Process 600 is an example of an alternative embodiment to process 500 in which a single set of criteria is used for switching between uplink transmission modes. The operations may vary in other examples. The operations of process 600 are performed by an access node, such as access node 110 in the example of FIG. 1.

The operations of process 600 include monitoring uplink transmission conditions for user equipment (step 605). In step 605, the UE is operating in the ULCA transmission mode. In the example of FIG. 1, access node 110 monitors uplink transmission conditions for UE 105 using metrics 125 while UE 105 is using ULCA. The operations of process 600 further include comparing one or more metrics to one or more criteria (step 610). In the example of FIG. 1, access node 110 compares one or more metrics of metrics 125 to predetermined criteria associated with the determination of whether UE 105 should be operating in UL MIMO. The one or more criteria, in some examples, includes at least one threshold for signal quality, signal strength, and/or transmission reliability. The operations of process 600 further include determining whether the one or more criteria are met (step 615). In the example of FIG. 1, access node 110 determines whether one or more metrics of metrics 125 satisfy the predetermined criteria associated with the determination to switch from ULCA to UL MIMO.

If the one or more criteria are not met, the operations of process 600 return to step 605, monitoring uplink transmission conditions for the UE. If the one or more criteria are met, the operations of process 600 proceed to step 620, sending a configuration message to instruct the UE to switch to UL MIMO. In the example of FIG. 1, access node 110 sends configuration message 130 to UE 105 to instruct UE 105 to switch to the UL MIMO uplink transmission mode. In some examples, the configuration message also instructs UE 105 to release one or more ULCA resources before switching to UL MIMO. The operations of process 600 further include monitoring the uplink transmission conditions for the UE (step 625). In the example of FIG. 1, UE 105 switches to UL MIMO from ULCA in response to configuration message 130 sent in step 620. Once UE 105 has switched, access node 110 monitors the uplink transmission conditions for UE 105 via metrics 125.

The operations of process 600 further include comparing one or more metrics to the one or more criteria (step 630). In the example of process 600, the one or more criteria in step 630 are the same one or more criteria that were used in step 610. In the example of FIG. 1, access node 110 compares one or more metrics of metrics 125 sent by UE 105 to the predetermined criteria associated with the determination to switch to ULCA from UL MIMO. The operations of process 600 further include determining whether the one or more criteria are still met (step 635). In the example of FIG. 1, access node 110 determines whether one or more metrics of metrics 125 still satisfy the predetermined criteria associated with the determination to switch from ULCA to UL MIMO.

If the one or more criteria are still met, the operations of process 600 return to step 625, monitoring uplink transmission conditions for the UE while the UE is operating in UL MIMO. If the one or more criteria are no longer met, the operations of process 600 proceed to step 640, sending a configuration message to instruct the UE to switch back to ULCA. In the example of FIG. 1, access node 110 sends configuration message 130 to UE 105 to instruct UE 105 to switch back to the ULCA uplink transmission mode. In some examples, the configuration message also instructs UE 105 to release one or more UL MIMO resources before switching back to ULCA. The operations of process 600 return to monitoring the uplink transmission conditions for the UE (step 605). In the example of FIG. 1, UE 105 switches to ULCA from UL MIMO in response to configuration message 130 and access node 110 monitors the metrics 125 while UE 105 operates in ULCA.

The one or more criteria used in process 600 are described as determining whether the user equipment should switch to UL MIMO from ULCA and/or back to ULCA from UL MIMO. In other words, ULCA operates as the default mode for the user equipment, and the user equipment is only instructed to use UL MIMO when the criteria remain satisfied. In other examples, however, user equipment may use UL MIMO as a default mode. In such an example, the one or more criteria used would correspond to determining whether the user equipment should switch to ULCA from UL MIMO and/or back to UL MIMO from ULCA.

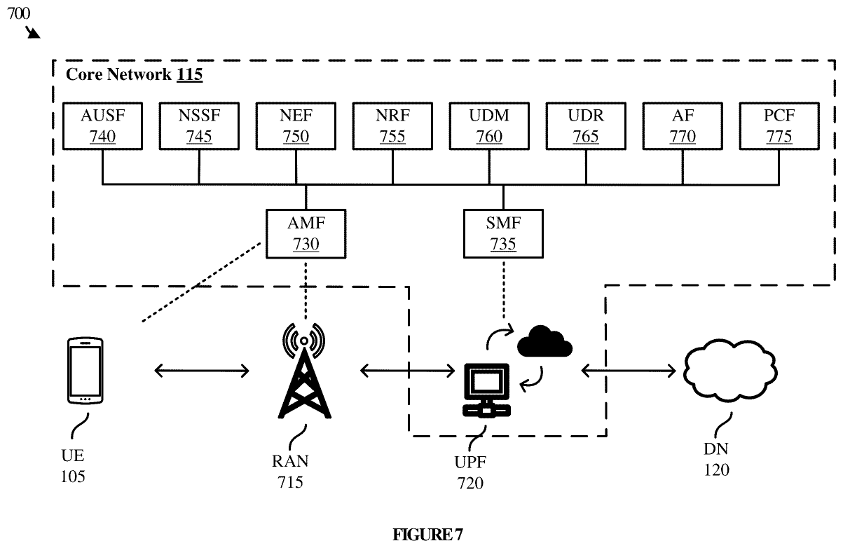

FIG. 7 illustrates 5G communication network 700. 5G communication network 700 is representative of a 5G communication network as disclosed herein in which network-controlled switching of uplink transmission modes may be implemented. 5G communication network 700 may be representative of wireless communications environment 100 in FIG. 1, ULCA environment 200 in FIG. 2, and/or UL MIMO environment 300 in FIG. 3, in some examples. 5G communication network 700 includes core network 115, UE 105, radio access network (RAN) 715, user plane function (UPF) 720, and data network 120. Core network 115 includes Access and Mobility Management Function (AMF) 730, Session Management Function (SMF) 735, Authentication Server Function (AUSF) 740, Network Slice Selection Function (NSSF) 745, Network Exposure Function (NEF) 750, Network Repository Function (NRF) 755, Unified Data Management (UDM) 760, Unified Data Repository (UDR) 765, Application Function (AF) 770, and Policy Control Function (PCF) 775. RAN 715, in some examples, includes access node 110 from the preceding Figures. In other examples, 5G communication network 700 may include different or additional elements than those illustrated in FIG. 7 including but not limited to a session communication proxy (SCP), a migration function, a provisioning orchestrator, a customer relationship management (CRM) client, and the like.

AMF 730 is responsible for access and mobility management including the initial registration of devices, authentication, tracking area management, and ensuring that users remain connected as they move through the network. AMF 730 serves as the point of contact for a user device (e.g., UE 105) when it tries to connect to the 5G network (e.g., 5G communication network 700). AMF 730 manages the establishment, maintenance, and termination of the connection between UE 105 and core network 115. SMF 735 is responsible for session management including establishing, modifying, and releasing sessions (which comprise of one or more data flows). SMF 735 also selects and manages the user plane functions, handles aspects of internet protocol (IP) address allocation, and maintains the rules for how data should be routed and reported. SMF 735 ensures that data can be successfully transmitted between UE 105 and the internet or other network services.

AUSF 740 is also responsible for aspects of user authentication. AUSF, in part, generates and validates authentication vectors to ensure that the requesting device is a legitimate subscriber of 5G communication network 700. Upon successful authentication, AUSF 740 contributes to establishing a secure communication channel between UE 105 and core network 115 by facilitating the generation and distribution of security keys. AUSF 740 may also support network slicing by authenticating access to different network slices based on user subscription. AUSF 740 also supports roaming by interacting with corresponding authentication functions in other networks.

NSSF 745 is responsible for selecting the appropriate network slice for UE 105 based on UE 105's subscription data and requested service. This may involve determining which slice or slices are best suited to meet the specific service requirements and the subscription profile associated with UE 105. NSSF 745 is also responsible for enforcing policies related to network slice access, managing information about the network slices, and interacting with other core network functions to ensure that UE 105 is connected to the correct slice and that slice-specific rules are applied.

NEF 750 plays a role in securely exposing the capabilities of core network 115 to external applications and services. NEF 750 may perform functions such as providing standardized application programming interfaces (APIs) for third-party services to access specific network capabilities or information and ensuring that the exposure of network capabilities and user data is managed securely and user privacy is maintained. NRF 755 acts as a central registry and discovery service for the network functions within core network 115. NRF 755 allows other network functions to register their services and discover the services provided by other network functions, maintains up-to-date information on the services offered by different network functions, supports load balancing and fault tolerance mechanisms within the network, and supports the scalability of the network.

UDM 760 is a central entity for managing subscriber data and authentication information. UDM 760 stores and manages subscription-specific information and is responsible for handling the authentication and authorization of users trying to access the network. Although not directly managing sessions, UDM 760 provides necessary information to other network functions, such as AMF 730 and SMF 735, to assist in session establishment and management based on the subscriber's data. UDM 760 also supports seamless service continuity and roaming by managing user identities and security information across different types of networks.

UDR 765 acts as a database (or multiple databases) for storing and managing structured subscriber data and service information. UDR 765 manages access to subscription data for other network functions such as AMF 730, SMF 735, and UDM 760. AF 770 is representative of external applications and services that may need to interact with core network 115 for various purposes. PCF 775 is responsible for policy management, which involves creating and enforcing policy rules for network behavior and user data transmission.

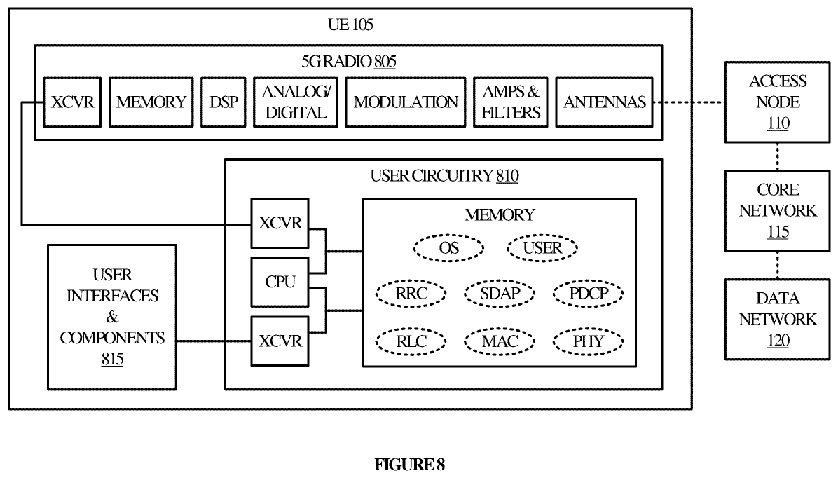

FIG. 8 illustrates an example of UE 105 from the preceding Figures in which UE 105 is configured for use in a 5G network (e.g., 5G communication network 700). In the example of FIG. 8, UE 105 is wirelessly coupled to access node 110, core network 115 via access node 110, and data network 120 via core network 115. UE 105 may differ from what is shown in the example of FIG. 8. UE 105, in the example of FIG. 8, includes 5G radio 805, user circuitry 810, and user interfaces and components 815. 5G radio 805 includes 5GNR antennas, amplifiers, filters, modulation, analog-to-digital interfaces, digital signaling processors (DSPs), memory, and radio transceiver circuitry (XCVR) that are coupled over bus circuitry. User circuitry 810 includes memory, CPU, and XCVRs that are coupled over bus circuitry.

The memory in user circuitry 810 stores an operating system (OS), user applications (USER), and 5GNR network applications for the physical layer (PHY), MAC layer, radio link control (RLC), packet data convergence protocol (PDCP), service data adaptation protocol (SDAP), and RRC. The antennas in 5G radio 805 are wirelessly coupled to access node 110 over a 5GNR link. Transceivers in 5G radio 805 are coupled to a transceiver in user circuitry 810. Another transceiver in user circuitry 810 is coupled to user interfaces and components 815, which may include displays, controllers, and/or memory.

In 5G radio 805, the antennas receive wireless signals from access node 110 that transport downlink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding 5GNR symbols to user circuitry 810 over the transceivers.

In user circuitry 810, the CPU executes the network applications to process the 5GNR symbols and recover the downlink 5GNR signaling and data. The 5GNR network applications receive new uplink signaling and data from the user applications. The network applications process the uplink user signaling and the downlink 5GNR signaling to generate new downlink user signaling and new uplink 5GNR signaling. The network applications transfer the new downlink user signaling and data to the user applications. The 5GNR network applications process the new uplink 5GNR signaling and user data to generate corresponding uplink 5GNR symbols that carry the uplink 5GNR signaling and data. The CPU and associated network applications also coordinate with the MAC and RRC layers to facilitate dynamic uplink transmission mode switching (i.e., between ULCA and UL MIMO) based on network instructions from access node 110.

In 5G radio 805, the DSP processes the uplink 5GNR symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless 5GNR signals to access node 110 that transport the uplink 5GNR signaling and data. The uplink transmission mode (UL MIMO or ULCA) is determined based on signaling/messaging received from access node 110, which evaluates real-time uplink transmission metrics.

RRC functions may include but are not limited to authentication, security, handover control, status reporting, QoS, network broadcasts and pages, and network selection. SDAP functions may include but are not limited to QoS marking and flow control. PDCP functions may include but are not limited to security ciphering, header compression and decompression, sequence numbering and re-sequencing, de-duplication. RLC functions may include but are not limited to automatic repeat request (ARQ), sequence numbering and resequencing, segmentation and resegmentation.

MAC functions may include but are not limited to buffer status, power control, channel quality, HARQ, user identification, random access, user scheduling, and QoS. The MAC layer interacts with the RRC layer to support mode switching decisions based on buffer status reports (BSRs) and channel quality indicators (CQIs) received from UE 105. PHY functions may include but are not limited to packet formation/deformation, windowing/de-windowing, guard-insertion/guard-deletion, parsing/de-parsing, control insertion/removal, interleaving/de-interleaving, forward error correction (FEC) encoding/decoding, channel coding/decoding, channel estimation/equalization, and rate matching/de-matching, scrambling/descrambling, modulation mapping/de-mapping, layer mapping/de-mapping, precoding, resource element (RE) mapping/de-mapping, fast Fourier transforms (FFTs)/inverse FFTs (IFFTs), and discrete Fourier transforms (DFTs)/inverse DFTs (IDFTs).

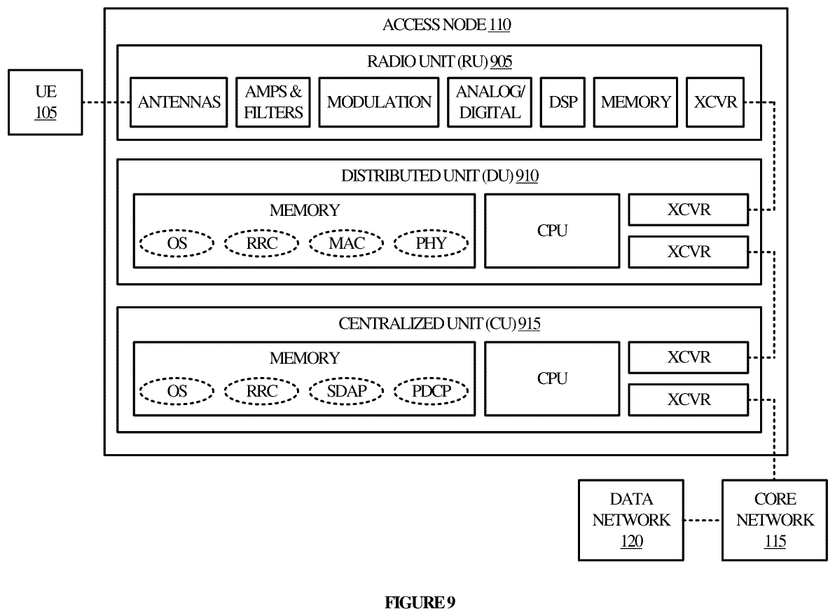

FIG. 9 illustrates an example of access node 110 from the preceding Figures in which access node 110 is a gNB configured for use in a 5G network (e.g., 5G communication network 700). In the example of FIG. 9, access node 110 is wireless coupled to UE 105, core network 115, and data network 120 via core network 115. Access node 110 may differ from what is shown in the example of FIG. 9. In the example of FIG. 9, access node 110 includes radio unit (RU) 905, distributed unit (DU) 910, and centralized unit (CU) 915. RU 905 may include but is not limited to antennas, amplifiers, filters, modulation, analog-to-digital interfaces, DSP, memory, and XVCRs that are coupled over bus circuitry. UE 105 is wirelessly coupled to antennas in RU 905 over 5GNR links. Transceivers in RU 905 are coupled to transceivers in DU 910 over fronthaul links like enhanced common public radio interface (eCPRI). The DSPs in RU 905 execute their operating systems and radio applications to exchange 5GNR signals with UE 105 and to exchange 5GNR data with DU 910.

For the uplink, the antennas in RU 905 receive wireless signals from UE 105 that transport uplink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR symbols to DU 910 over the transceivers.

For the downlink, the DSPs receive downlink 5GNR symbols from DU 910. The DSPs process the downlink 5GNR symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to UE 105 that transport the downlink 5GNR signaling and data.

DU 910 may include but is not limited to memory, CPU, and XCVRs that are coupled over bus circuitry. The memory in DU 910 stores operating systems (OS) and 5GNR network applications like RRC, MAC, and PHY. CU 915 may include but is not limited to memory, CPU, and XCVRs that are coupled over bus circuitry. The memory in CU 915 stores an OS and 5GNR network applications like PDCP, SDAP, and RRC. Transceivers in DU 910 may be coupled to transceivers in RU 905 over front-haul links. Transceivers in DU 910 may be coupled to transceivers in CU 915 over mid-haul links.

RRC functions may include but are not limited to connection establishment and release, radio bearer configuration, mobility control, paging coordination, and security configuration. The RRC layer may send control message to UEs to configure parameters for uplink and downlink configuration, including switching between UL MIMO and ULCA. MAC functions may include but are not limited to buffer status reporting, power control, channel quality measurement, HARQ management, user identification, random access coordination, user scheduling, and QoS enforcement. The MAC layer may be responsible for evaluating uplink buffer status reports (BSRs) and channel quality indicators (CQIs) to determine transmission efficiency, coordinating HARQ retransmissions to maintain reliability during uplink transmission mode transitions (e.g., between ULCA and UL MIMO), and dynamically scheduling uplink resources based on uplink transmission mode.

PHY functions may include but are not limited to packet formation/deformation, guard-insertion/guard-deletion, parsing/de-parsing, control insertion/removal, interleaving/de-interleaving, FEC encoding/decoding, channel coding/decoding, channel estimation/equalization, rate matching/de-matching, scrambling/descrambling, modulation mapping/de-mapping, layer mapping/de-mapping, precoding, RE mapping/de-mapping, FFTs/IFFTs, and DFTs/IDFTs.

PDCP functions may include but are not limited to security ciphering, header compression and decompression, sequence numbering and re-sequencing, de-duplication. SDAP functions include QoS marking and flow control. RRC functions may include but are not limited to authentication, security, handover control, status reporting, QoS, network broadcasts and pages, network selection, signal-to-interference-plus-noise ratio (SINR) calculation, transmitter power tracking, feature vector preparation, and cell bandwidth control.

Although the descriptions provided herein may be in the context of certain radio access technologies, networks, and network topologies, such as 4G LTE or 5G/NR mobile communications, the proposed concepts, schemes, and any variations thereof may be implemented in, for, and by other types of radio access technologies, networks, and network topologies. Such radio access technologies, networks, and network topologies may include, for example and without limitation, Internet-of-Things (IoT), Narrow Band Internet of Things (NB-IoT), vehicle-to-everything (V2X), fixed wireless internet, non-terrestrial networks (NTN), and space-based technologies, such as communications involving low Earth orbit (LEO), medium Earth orbit (MEO), or geostationary orbit (GEO) satellites. Thus, the scope of the disclosure is not limited to the examples described herein.

As will be appreciated by one skilled in the art, aspects of the present technology may be embodied as a system, method, computer program product, or otherwise. Accordingly, aspects of the present technology may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present technology may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the technology disclosed herein is not limited to the specific implementations described above, but only by the claims and their equivalents.

The wireless data network circuitry described above comprises computer hardware and software that form special-purpose wireless system circuitry to serve wireless user devices based on policies. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose wireless system circuitry to serve wireless user devices based on policies.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms ‘connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents. The above Detailed Description of examples of the technology is not intended to be exhaustive or to limit the technology to the precise form disclosed above. While specific examples of the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above but also may include fewer elements.

These and other changes can be made to the technology in light of the above Detailed Description. While the above description describes certain examples of technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method comprising:
receiving, via a wireless communication network, at least one uplink transmission metric from a user device, wherein the at least one uplink transmission metric indicates uplink channel conditions;
determining, based on the at least one uplink transmission metric, that the at least one uplink transmission metric satisfies one or more predefined criteria corresponding to a first uplink transmission mode;
sending, via the wireless communication network, a configuration message to the user device instructing the user device to operate in the first uplink transmission mode; and
receiving, via the wireless communication network, at least one uplink transmission from the user device while the user device is operating in the first uplink transmission mode.

2. The method of claim 1, further comprising:
determining that the at least one uplink transmission metric satisfies one or more predefined second criteria corresponding to a second uplink transmission mode; and
sending, via the wireless communication network, a second configuration message to the user device instructing the user device to switch to the second uplink transmission mode.

3. The method of claim 2, wherein the first uplink transmission mode comprises an uplink multiple-input multiple-output (UL MIMO) mode and the second uplink transmission mode comprises an uplink carrier aggregation (ULCA) mode.

4. The method of claim 3, wherein the second configuration message further instructs the device to release one or more UL MIMO resources before switching to the second uplink transmission mode.

5. The method of claim 2, wherein the one or more predefined second criteria corresponding to the second uplink transmission mode are satisfied when the one or more predefined criteria are not satisfied.

6. The method of claim 1, wherein the at least one uplink transmission metric comprises at least one of a sounding reference signal, a demodulation reference signal, a transmit precoding matric indicator, and hybrid automatic repeat request feedback.

7. The method of claim 1, wherein the configuration message comprises a radio resource control message.

8. The method of claim 1, wherein the predefined criteria corresponding to the first uplink transmission mode includes a threshold for one or more of signal quality, signal strength, and transmission reliability.

9. A system comprising:
one or more computer-readable storage media;
a processing system operatively coupled with the one or more computer-readable storage media; and
program instructions stored on the one or more computer-readable storage media,
wherein the program instructions, when read and executed by the processing system, direct the processing system to at least:
receive, via a wireless communication network, at least one uplink transmission metric from a user device, wherein the at least one uplink transmission metric indicates uplink channel conditions;
determine, based on the at least one uplink transmission metric, that the at least one uplink transmission metric satisfies one or more predefined criteria corresponding to a first uplink transmission mode;
send, via the wireless communication network, a configuration message to the user device instructing the user device to operate in the first uplink transmission mode; and
receive, via the wireless communication network, at least one uplink transmission from the user device while the user device is operating in the first uplink transmission mode.

10. The system of claim 9, wherein the program instructions, when read and executed by the processing system, further direct the processing system to:
determine that the at least one uplink transmission metric satisfies one or more predefined second criteria corresponding to a second uplink transmission mode; and
send, via the wireless communication network, a second configuration message to the user device instructing the user device to switch to the second uplink transmission mode.

11. The system of claim 10, wherein the first uplink transmission mode comprises an uplink multiple-input multiple-output (UL MIMO) mode and the second uplink transmission mode comprises an uplink carrier aggregation (ULCA) mode.

12. The system of claim 11, wherein the second configuration message further instructs the device to release one or more UL MIMO resources before switching to the second uplink transmission mode.

13. The system of claim 10, wherein the one or more predefined second criteria corresponding to the second uplink transmission mode are satisfied when the one or more predefined criteria are not satisfied.

14. The system of claim 9, wherein the at least one uplink transmission metric comprises at least one of a sounding reference signal, a demodulation reference signal, a transmit precoding matric indicator, and hybrid automatic repeat request feedback.

15. The system of claim 9, wherein the configuration message comprises a radio resource control message.

16. The system of claim 9, wherein the predefined criteria corresponding to the first uplink transmission mode includes a threshold for one or more of signal quality, signal strength, and transmission reliability.

17. One or more non-transitory computer-readable storage media having program instructions stored thereon, wherein the program instructions, when executed by a computing system, direct the computing system to perform operations, the operations comprising:
receiving, via a wireless communication network, at least one uplink transmission metric from a user device, wherein the at least one uplink transmission metric indicates uplink channel conditions;
determining, based on the at least one uplink transmission metric, that the at least one uplink transmission metric satisfies one or more predefined criteria corresponding to a first uplink transmission mode;
sending, via the wireless communication network, a configuration message to the user device instructing the user device to operate in the first uplink transmission mode; and
receiving, via the wireless communication network, at least one uplink transmission from the user device while the user device is operating in the first uplink transmission mode.

18. The one or more non-transitory computer-readable storage media of claim 17, the operations further comprising:
determining that the at least one uplink transmission metric no longer satisfies the one or more predefined criteria corresponding to the first uplink transmission mode; and
sending, via the wireless communication network, a second configuration message to the user device instructing the user device to switch to a second uplink transmission mode.

19. The one or more non-transitory computer-readable storage media of claim 18, wherein the first uplink transmission mode comprises an uplink multiple-input multiple-output (UL MIMO) mode and the second uplink transmission mode comprises an uplink carrier aggregation (ULCA) mode.

20. The one or more non-transitory computer-readable storage media of claim 19, wherein the second configuration message further instructs the device to release one or more UL MIMO resources before switching to the second uplink transmission mode.
